(19) United States
(12) Patent Application Publication
(10) Pub. No.: US 2023/0054244 A1
(43) Pub. Date: Feb. 23, 2023

(54) NETWORK MIGRATION METHOD AND APPARATUS, COMMUNICATIONS DEVICE, AND COMMUNICATIONS SYSTEM

(71) Applicant: VIVO MOBILE COMMUNICATION CO., LTD., Guangdong (CN)

(72) Inventor: Jinhua LIU, Guangdong (CN)

(73) Assignee: VIVO MOBILE COMMUNICATION CO., LTD., Guangdong (CN)

(21) Appl. No.: 17/982,380

(22) Filed: Nov. 7, 2022

Related U.S. Application Data
(63) Continuation of application No. PCT/CN2021/096961, filed on May 28, 2021.

(30) Foreign Application Priority Data
May 29, 2020 (CN) 202010480061.8

(51) Int. Cl. H04W 36/14; H04W 36/00

(52) U.S. Cl. CPC H04W 36/14; H04W 36/0055

(57) ABSTRACT

A network migration method and apparatus, a communications device, and a communications system. The method includes: sending a migration request message to a target CU, where the migration request message includes first target information, and the first target information is context information of a DU of a migrating IAB node; receiving a migration response message sent by the target CU, where the migration response message includes first configuration information, and the first configuration information is information for network migration configured by the target CU for the DU; and sending the first configuration information to the IAB node, where the first configuration information is for use by the IAB node to implement a migration procedure of the DU.

### CROSS-REFERENCE TO RELATED APPLICATIONS

This application is a continuation of International Application No. PCT/CN2021/096961 filed on May 28, 2021, which claims priority to Chinese Patent Application No. 202010480061.8, filed on May 29, 2020, which are incorporated herein by reference in their entireties.

### TECHNICAL FIELD

This application relates to the field of communication technologies, and specifically to a network migration method and apparatus, a communications device, and a communications system.

### BACKGROUND

An integrated access backhaul (IAB) system includes a distributed unit (DU) function part and a mobile termination (MT) function part. In one integrated access backhaul loop, DUs of all IAB nodes are connected to one centralized unit (CU) node, and that CU node performs configuration for the DUs and MTs.

During inter-CU IAB node migration, a migrating IAB node migrates from a source parent IAB node controlled by a source CU to a target parent IAB node controlled by a target CU, meaning that during the migration, both IAB-MT and IAB-DU of the migrating IAB node need to migrate so as to connect to a donor IAB node and to be controlled by the target CU.

However, there is no solution in the related art at present how a migrating IAB-DU migrates to a target CU, and therefore migration of an IAB node from a source network (that is, network controlled by a source CU) to a target network (network controlled by a target CU) cannot be realized.

### SUMMARY

According to a first aspect, a network migration method is provided and applied to a source CU. The network migration method includes: sending a migration request message to a target CU, where the migration request message includes first target information, and the first target information is context information of a DU of a migrating IAB node; receiving a migration response message sent by the target CU, where the migration response message includes first configuration information, and the first configuration information is information for network migration configured by the target CU for the DU; and sending the first configuration information to the IAB node, where the first configuration information is for use by the IAB node to implement a migration procedure of the DU.

According to a second aspect, a network migration method is provided and applied to a target CU. The network migration method includes: receiving a migration request message sent by a source CU, where the migration request message includes first target information, and the first target information is context information of a DU of a migrating IAB node; and sending a migration response message to the source CU according to the migration request message, where the migration response message includes first configuration information, and the first configuration information is information for network migration configured by the target CU for the DU.

According to a third aspect, a network migration method is provided and applied to an IAB node. The network migration method includes: receiving first configuration information sent by a source CU, where the first configuration information is information for network migration configured by a target CU for a DU of the IAB node; and implementing a migration procedure of the DU according to the first configuration information.

According to a fourth aspect, a network migration apparatus is provided. The network migration apparatus includes a sending module and a receiving module. The sending module is configured to send a migration request message to a target CU, where the migration request message includes first target information, and the first target information is context information of a DU of a migrating IAB node. The receiving module is configured to receive a migration response message sent by the target CU, where the migration response message includes first configuration information, and the first configuration information is information for network migration configured by the target CU for the DU. The sending module is further configured to send the first configuration information to the IAB node, where the first configuration information is for use by the IAB node to implement a migration procedure of the DU.

According to a fifth aspect, a network migration apparatus is provided. The network migration apparatus includes a receiving module and a sending module. The receiving module is configured to receive a migration request message sent by a source CU, where the migration request message includes first target information, and the first target information is context information of a DU of a migrating IAB node. The sending module is configured to send a migration response message to the source CU according to the migration request message, where the migration response message includes first configuration information, and the first configuration information is information for network migration configured by a target CU for the DU.

According to a sixth aspect, a network migration apparatus is provided. The network migration apparatus includes a receiving module and an execution module. The receiving module is configured to receive first configuration information sent by a source CU, where the first configuration information is information for network migration configured by a target CU for a DU of an IAB node. The execution module is configured to implement a migration procedure of the DU according to the first configuration information.

According to a seventh aspect, a CU is provided. The CU includes a processor, a memory, and a program or instructions stored in the memory and capable of running on the processor. When the program or instructions are executed by the processor, the steps of the network migration method according to the first aspect are implemented.

According to an eighth aspect, a CU is provided. The CU includes a processor, a memory, and a program or instructions stored in the memory and capable of running on the processor. When the program or instructions are executed by the processor, the steps of the network migration method according to the second aspect are implemented.

According to a ninth aspect, an IAB node is provided. The IAB node includes a processor, a memory, and a program or instructions stored in the memory and capable of running on the processor. When the program or instructions are executed by the processor, the steps of the network migration method according to the third aspect are implemented.

According to a tenth aspect, a communications system is provided. The communications system includes the network migration apparatus according to the fourth aspect, the network migration apparatus according to the fifth aspect, and the network migration apparatus according to the sixth aspect; or the communications system includes the CU according to the seventh aspect, the CU according to the eighth aspect, and the IAB node according to the ninth aspect.

According to an eleventh aspect, a readable storage medium is provided. The readable storage medium stores a program or instructions, and when the program or instructions are executed by a processor, the steps of the network migration method according to the first aspect or the steps of the network migration method according to the second aspect or the steps of the network migration method according to the third aspect are implemented.

According to a twelfth aspect, a chip is provided. The chip includes a processor and a communications interface. The communications interface is coupled to the processor, and the processor is configured to run a program or instructions so as to implement the network migration method according to the first aspect, or the network migration method according to the second aspect, or the network migration method according to the third aspect.

### BRIEF DESCRIPTION OF DRAWINGS

FIG. 1 is a schematic diagram of an architecture of an IAB system according to an embodiment of this application;

FIG. 2 is a block diagram of a wireless communications system according to an embodiment of this application;

FIG. 3 is a schematic diagram of a CU-DU structure of an IAB system according to an embodiment of this application;

FIG. 4 is a first schematic diagram of a network migration method according to an embodiment of this application;

FIG. 5 is a second schematic diagram of a network migration method according to an embodiment of this application;

FIG. 6 is a first schematic structural diagram of a network migration apparatus according to an embodiment of this application;

FIG. 7 is a second schematic structural diagram of a network migration apparatus according to an embodiment of this application;

FIG. 8 is a third schematic structural diagram of a network migration apparatus according to an embodiment of this application;

FIG. 9 is a schematic structural diagram of a communications device according to an embodiment of this application;

FIG. 10 is a schematic diagram of hardware of a CU according to an embodiment of this application; and

FIG. 11 is a schematic diagram of hardware of an IAB node according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the data used in this way is interchangeable in appropriate circumstances so that the embodiments of this application can be implemented in other orders than the order illustrated or described herein. Moreover, the objects distinguished by “first” and “second” are usually of one type, and the number of objects is not limited. For example, the first object may be one or more than one. In addition, “and/or” in the specification and claims represents at least one of connected objects, and the character “/” generally indicates that the associated objects have a “or” relationship.

Some concepts and/or terms used in the network migration method and apparatus, the communications device, and the communications system that are provided in the embodiments of this application are explained below.

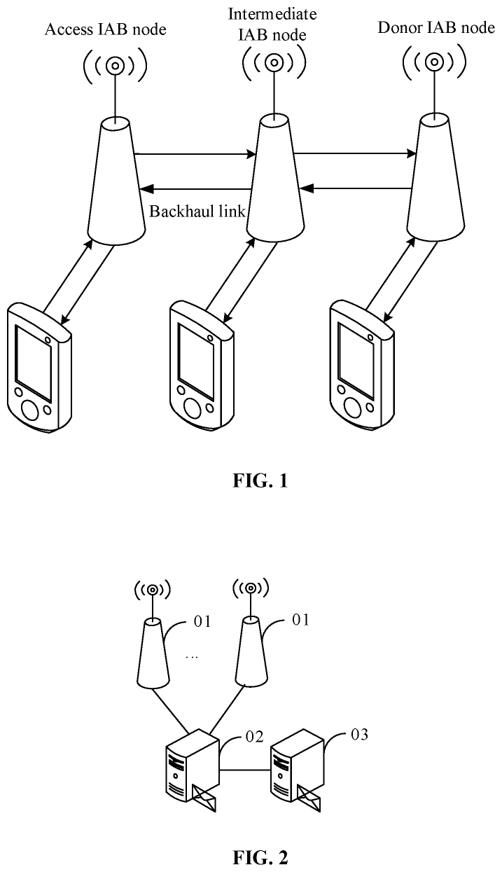

IAB system: FIG. 1 is a schematic diagram of an architecture of an IAB system. An IAB node includes a DU function part and an MT function part. Relying on the MT, one access point (that is, the IAB node) can find an upstream access point (parent IAB node) and establish a wireless connection with a DU of the upstream access point, where the wireless connection is referred to as a backhaul link. After the IAB node establishes a complete backhaul link, the IAB node enables its DU function so that the DU provides cell service, that is, the DU is able to provide access service for user equipment (UE). A backhaul loop includes one donor IAB node (or referred to as IAB donor), and the donor IAB node has a directly connected wired transmission network. The IAB system is introduced in order to solve the lack of deployment of a wired transmission network in the case of dense deployment of access points. That is, when there is no wired transmission network, access points can rely on wireless backhaul.

UE may also be called a terminal device, which may be a terminal side device such as a mobile phone, a tablet personal computer, a laptop computer or notebook computer, a personal digital assistant (PDA), a handheld computer, a netbook, an ultra-mobile personal computers (UMPC), a mobile Internet device (MID), a wearable device, a vehicle-mounted user equipment (VUE), or a pedestrian user equipment (PUE). The wearable device includes a bracelet, an earphone, glasses, and the like. It should be noted that a specific type of the UE is not limited in the embodiments of this application.

It is worth noting that the technology described in the embodiments of this application is not limited to long term evolution (LTE)/LTE-Advanced (LTE-A) systems, but may also be used in other wireless communications systems such as code division multiple access (CDMA), time division multiple access (TDMA), frequency division multiple access (FDMA), orthogonal frequency division multiple access (OFDMA), single-carrier frequency division multiple access (SC-FDMA), and other systems. The terms “system” and “network” in the embodiments of this application are often used interchangeably, the technology described herein may be used in the above-mentioned systems and radio technologies as well as other systems and radio technologies. However, in the following descriptions, a new radio (NR) system is described for illustration purposes, and NR terms are used in most of the following descriptions, although these technologies may also be applied to other applications than the NR system application, for example, 6th generation (6G) communications systems.

FIG. 2 is a block diagram of a wireless communications system to which the embodiments of this application may be applied. The wireless communications system includes at least one IAB node 01, a source CU 02, and a target CU 03.

The at least one IAB node 01 may establish a connection with the source CU 02, and the source CU 02 may establish a connection with the target CU 03.

It should be noted that the connection between the at least one IAB node 01 and the source CU 02 and the connection between the source CU 02 and the target CU 03 may both be wireless. In FIG. 2, solid lines are used to indicate the connection between the at least one IAB node 01 and the source CU 02 and the connection between the source CU 02 and the target CU 03.

Information (for example, a migration request message in the embodiments of this application) can be exchanged between the source CU and the target CU to control the IAB node to implement network migration (for example, migration from a network controlled by the source CU to a network controlled by the target CU).

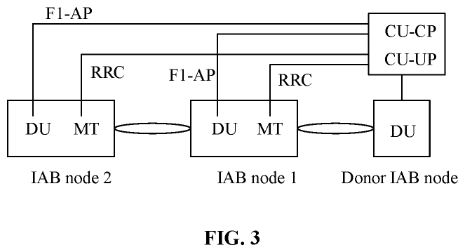

FIG. 3 is a schematic diagram of a CU-DU structure of an IAB system. In a backhaul loop, DUs of all IAB nodes are connected to one CU node, and that one CU node performs configurations for the DUs through F1 application protocol (F1-AP) signaling. The CU performs configuration for the MTs through RRC signaling. The donor IAB node has no MT function part.

The following specifically describes the network migration method provided in the embodiments of this application through specific embodiments and application scenarios thereof with reference to the accompanying drawings.

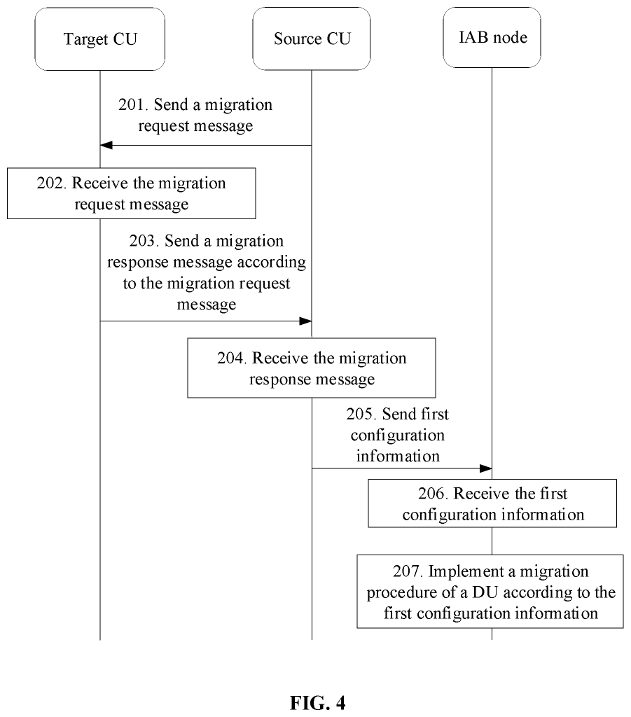

Based on the foregoing communications system, an embodiment of this application provides a network migration method. As shown in FIG. 4, the network migration method may include the following step 201 to step 207.

Step 201. A source CU sends a migration request message to a target CU.

In this embodiment of this application, the migration request message includes first target information, where the first target information is context information of a DU of a migrating IAB node.

Optionally, in this embodiment of this application, the first target information includes at least one of the following: system information of the DU, synchronization signal block (SSB) information of the DU, physical cell identifier (PCI) information/E-UTRAN cell global identity (ECGI) information of the DU, tracking area code (TAC) information of the DU, RANAC (that is, radio access network (RAN) based notification area code (AC)) information of the DU, uplink and downlink (that is, direction) information of the DU, capability information of the DU, uplink and downlink load of the DU, power allocation information between the DU and an MT of the IAB node, guard symbol (desired/provided guard symbol) information corresponding to the DU, and interference information of a backhaul/access link corresponding to the DU.

Optionally, in this embodiment of this application, the system information of the DU is any one of the following: master system information block (MIB) information, target system information block (SIB) information (for example, SIB1 information), and other SIB information, where the other SIB information is SIB information other than the target SIB information.

Optionally, in this embodiment of this application, the system information of the DU includes at least one of the following: public land mobile network (PLMN) information of a cell corresponding to the DU, bandwidth part (BWP) information corresponding to the DU, carrier information corresponding to the DU, slice information corresponding to the DU, general random access information corresponding to the DU, IAB-specific (specific) random access information corresponding to the DU, paging configuration information corresponding to the DU, neighboring cell information corresponding to the DU, cell selection configuration information corresponding to the DU, broadcast message transmission configuration information corresponding to the DU, and radio resource configuration information corresponding to the DU.

It should be noted that the system information of the DU is system information in effect of the DU, the SSB information is SSB configuration information being broadcast by the DU, and the general random access information is information that is usable for both the IAB node and UE; and the cell corresponding to the DU can be understood as a cell provided by the DU.

Optionally, in this embodiment of this application, the broadcast message transmission configuration information corresponding to the DU may include at least one of the following: a period, a list of messages being broadcast, a list of messages based on a migration request message, a system message request configuration, and the like.

Optionally, in this embodiment of this application, the SSB information may include at least one of the following: a time offset, a period, the number of SSBs (that is, value L), an SSB transmit power, an occupied frequency, and the like.

Optionally, in this embodiment of this application, the capability information of the DU includes at least one of the following: scheduling/transmission/reception processing latency of the DU, radio frequency information of the DU, band and carrier supported by the DU, dynamic power adjustment range of the DU, indication information whether the DU supports dual connectivity, indication information whether the DU supports EN-DC (EN stands for EUTRA-NR), multiplexing pattern supported by the DU, subcarrier spacing (SCS) information supported by an antenna configuration corresponding to the DU, scheduling pattern supported by the DU, discontinuous reception (DRX) function information of the DU, preemptive (pre-emptive) buffer status report (BSR) function information corresponding to the DU, downlink hop by hop flow control function information of the DU, radio resource control (RRC) inactive state function information corresponding to the DU, RRC idle state function information corresponding to the DU, traffic class information supported by the DU, and multiple input multiple output (MIMO) related capability information supported by the DU.

Optionally, in this embodiment of this application, the radio frequency information may include at least one of the following: a maximum transmit power or a minimum transmit power.

Optionally, in this embodiment of this application, the multiplexing pattern may include at least one of the following: across-hop time division multiplexing (TDM), frequency division multiplexing (FDM), space division multiplexing (SDM), and full duplexing.

Optionally, in this embodiment of this application, the antenna configuration may include at least one of the following: radio frequency channels/antennas for separate use by IAB-DU and IAB-MT, and radio frequency channels/antennas for common use by IAB-DU and IAB-MT.

Optionally, in this embodiment of this application, the scheduling pattern may include at least one of the following: type A and type B.

Optionally, in this embodiment of this application, the migration request message further includes third target information, where the third target information is relevant context information of the IAB node.

Optionally, in the embodiment of this application, the third target information includes at least one of the following: information about a BAP entity corresponding to the IAB node, configuration information of a backhaul (BH) radio link control (RLC) channel from the IAB node to a parent IAB node or a child IAB node, routing (route/path) configuration information of the IAB node, local offloading configuration information of the IAB node, bearer mapping configuration information of the IAB node, congestion status information of a route or BH RLC channel, measurement configuration information of the IAB node for an NR cell or LTE cell, and internet protocol (IP) address information corresponding to the IAB node.

Optionally, in this embodiment of this application, the information about the BAP entity may include at least one of the following: BAP address information and BAP address information of the parent/child IAB node.

Optionally, in this embodiment of this application, the migration request message further includes at least one of the following: capability information of the MT of the IAB node (that is, IAB-MT specific capability information) and type information of the MT, where the capability information is used to indicate a UE function supported by the MT, and the type information of the MT is used to indicate a type of the MT.

Optionally, in this embodiment of this application, the capability information may specifically be a minimum function set indication of the IAB-MT, where the minimum function set indication is used to indicate basic UE functions supported by the IAB-MT.

Optionally, in this embodiment of this application, the IP address information includes at least one of the following: an IP address of the IAB-DU and an IP address of the IAB-MT.

Optionally, in this embodiment of this application, the migration request message further includes second target information, where the second target information is context information of the MT of the IAB node.

Optionally, in this embodiment of this application, the migration response message further includes second configuration information, where the second configuration information is information for network migration configured by the target CU for the MT.

Optionally, in this embodiment of this application, the second configuration information includes at least one of the following: signaling radio bearer (SRB) information, data radio bearer (DRB) information, serving cell information, power control information, measurement report information, Uu cell configuration information of the DU, time-frequency resource configuration information, and routing information.

Optionally, in this embodiment of this application, the migration response message further includes at least one of the following: backhaul adaptation protocol (BAP) entity configuration information and target routing configuration information that are configured by the target CU for the IAB node, where the target routing configuration information is used to indicate a data forwarding routing relationship of the IAB node in a network controlled by the target CU.

Step 202. The target CU receives the migration request message sent by the source CU.

Step 203. The target CU sends a migration response message to the source CU according to the migration request message.

In this embodiment of this application, the migration response message includes first configuration information, where the first configuration information is information for network migration configured by the target CU for the DU.

In this embodiment of this application, the target CU may complete, based on the received context information of the DU of the IAB node, pre-configuration for the DU in a target network (for example, including a target CU-control plane (CP), a target CU-user plane (UP), and a target parent IAB-DU node).

Optionally, in this embodiment of this application, the target CU may establish a relevant pre-configuration for an F1 channel where the DU is connected to the migrating IAB-DU in the target network, so as to perform network migration configuration for the DU.

Optionally, in this embodiment of this application, after completing the configuration for the DU, the target CU may generate a migration response message regarding the IAB node, and send the migration response message to the source CU.

In this embodiment of this application, the target CU may decide whether to change the configuration for the migrating IAB-DU node, and packetize the configuration information of the migrating IAB-DU node into the migration response message.

Step 204. The source CU receives the migration response message sent by the target CU.

Step 205. The source CU sends first configuration information to the IAB node.

In this embodiment of this application, the first configuration information is for use by the IAB node to implement the migration procedure of the DU.

Step 206. The IAB node receives the first configuration information sent by the source CU.

Step 207. The IAB node implements the migration procedure of the DU according to the first configuration information.

In this embodiment of this application, the DU in the IAB node (which may be referred to as IAB-DU) may implement a network migration procedure (that is, a procedure of migrating from a network controlled by the source CU to a network controlled by the target CU) according to the received first configuration information, and send a reconfiguration complete message to the target CU after completing the network migration.

In the network migration method provided in this embodiment of this application, the source CU can send the context information of the DU of the migrating IAB node to the target CU, so that the target CU can send the first configuration information (that is, the information for network migration configured by the target CU for the DU) to the source CU according to the context information of the DU; and the source CU sends the first configuration information to the IAB node, so that the IAB node implements the migration procedure of the DU according to the first configuration information. In this way, the migrating IAB-DU can migrate from a source network to a target network.

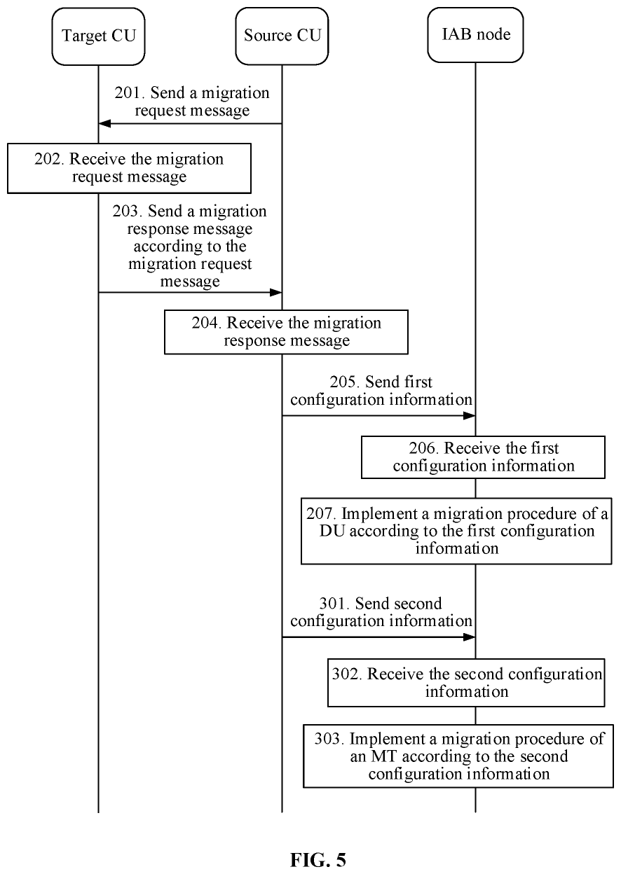

Optionally, in this embodiment of this application, with reference to FIG. 4, as shown in FIG. 5, after the foregoing step 204, the network migration method provided in this embodiment of this application further includes the following step 301 to step 303.

Step 301. The source CU sends second configuration information to the IAB node.

In this embodiment of this application, the second configuration information is information for network migration configured by the target CU for the MT, and the second configuration information is for use by the IAB node to implement the migration procedure of the MT.

Step 302. The IAB node receives the second configuration information sent by the source CU.

Step 303. The IAB node implements a migration procedure of the MT according to the second configuration information.

It should be noted that there is no limitation on the execution sequence of the foregoing steps 301 to 303 and the foregoing steps 205 to 207. In one implementation (the implementation shown in FIG. 5), steps 205 to 207 may be executed before steps 301 to 303; or in another implementation, steps 301 to 303 may be executed before steps 205 to 207; or in still another implementation, steps 205 to 207 may be executed at the same time as steps 301 to 303.

In this embodiment of this application, the source CU can send the context information of the MT of the migrating IAB node to the target CU, so that the target CU can send the second configuration information (that is, the information for network migration configured by the target CU for the MT) to the source CU according to the context information of the MT; and the source CU sends the second configuration information to the IAB node, so that the IAB node implements a migration procedure of the MT according to the second configuration information. In this way, the migrating IAB-MT can migrate from a source network to a target network.

The migration procedure of the migrating IAB node from a source CU network to a target CU network according to the embodiments of this application is described through specific embodiments (that is, the following steps 1 to 11).

Step 1. A source CU sends a migration request of a migrating IAB node to a target CU. The migration request message may include context (CONTEXT) information of an IAB-MT of the IAB node and context (CONTEXT) information of an IAB-DU of the IAB node.

Step 2. The target CU completes pre-configuration for the IAB-MT in a target network (including a target CU-CP, a target CU-UP, and a target parent IAB node) based on the received context information of the IAB-MT of the IAB node, for example, including configuration of radio bearer (for example, SRB and DRB) information and configuration of BAP entity (BAP entity).

Step 3. The target CU completes pre-configuration for the IAB-DU in the target network (including a target CU-CP, a target CU-UP, and a target parent IAB-DU node) based on the received context information of the IAB-DU of the IAB node, for example, including pre-configuration associated with establishment of an F1 channel connected to the migrating IAB-DU on the target network.

Step 4. The target CU performs routing pre-configuration on the IAB-MT and IAB-DU of the migrating IAB node on the target network, where the routing pre-configuration is to establish a data forwarding routing relationship on the target network for the migrating IAB node.

Step 5. After completing the foregoing steps 2, 3, and 4, the target CU generates a migration response message regarding the migrating IAB node, and sends the migration response message to the source CU.

The migration response message includes the pre-configuration information provided by the target CU for the IAB-MT and IAB-DU of the migrating IAB node. The pre-configuration information provided by the target CU for the migrating IAB-MT includes conventional configuration information (for example, SRB, DRB, serving cell, power control, and measurement report), and may also include routing BAP entity configuration information and routing configuration information. The pre-configuration information provided by the target CU for the migrating IAB-MT includes Uu cell configuration information of the IAB-DU, usable time-frequency resource configuration information, and routing information.

Step 6. After receiving the pre-configuration information provided by the target CU for the IAB-DU of the migrating IAB node, the source CU sends the pre-configuration information to the migrating IAB-DU, and the migrating IAB-DU completes the pre-configuration according to the received pre-configuration message.

Step 7. After successfully sending the pre-configuration information of the IAB-DU of the migrating IAB node, the source CU sends the pre-configuration information of the IAB-MT of the migrating IAB node provided by the target CU to the IAB-MT, and the IAB-MT completes the pre-configuration according to the received pre-configuration information.

Step 8. The IAB-MT of the migrating IAB node initiates a random access procedure according to the pre-configuration to establish a wireless connection with the target parent IAB node.

Step 9. The IAB-MT of the migrating IAB node sends a reconfiguration complete message to the target CU.

Step 10. The IAB-DU of the migrating IAB node sends a reconfiguration complete message to the target CU.

Step 11. The target CU node notifies the source IAB node that the migration is successfully completed, and the source IAB node starts a signaling procedure regarding context deletion information of the migrating IAB node.

In this embodiment of this application, the source CU can send the context information of the DU of the migrating IAB node and the context information of the MT of the migrating IAB node to the target CU, so that the target CU can send configuration information (that is, the first configuration information) of the DU and configuration information of the MT (that is, the second configuration information) to the source CU according to the context information of the DU and the context information of the MT; and the source CU sends the configuration information of the DU and the configuration information of the MT to the IAB node, so that the IAB node implements the migration procedure of the DU based on the configuration information of the DU and the migration procedure of the MT based on the configuration information of the MT. In this way, the migrating IAB node (that is, the IAB-DU and the IAB-MT) can migrate from a source network to a target network.

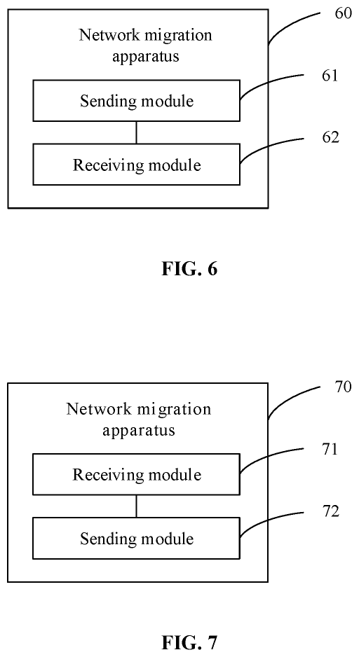

FIG. 6 is a possible schematic structural diagram of a network migration apparatus according to an embodiment of this application. As shown in FIG. 6, the network migration apparatus 60 provided in this embodiment of this application may include a sending module 61 and a receiving module 62.

The sending module 61 is configured to send a migration request message to a target CU, where the migration request message includes first target information, and the first target information is context information of a DU of a migrating IAB node. The receiving module 62 is configured to receive a migration response message sent by the target CU, where the migration response message includes first configuration information, and the first configuration information is information for network migration configured by the target CU for the DU. The sending module 61 is further configured to send the first configuration information to the IAB node, where the first configuration information is for use by the IAB node to implement a migration procedure of the DU.

In a possible implementation, the migration request message further includes second target information, and the second target information is context information of an MT of the IAB node; and the migration response message further includes second configuration information, where the second configuration information is information for network migration configured by the target CU for the MT. The sending module 61 is further configured to send the second configuration information to the IAB node, where the second configuration information is for use by the IAB node to implement a migration procedure of the MT.

In a possible implementation, the second configuration information includes at least one of the following: SRB information, DRB information, serving cell information, power control information, measurement report information, Uu cell configuration information of the DU, time-frequency resource configuration information, and routing information.

In a possible implementation, the migration response message further includes at least one of the following: BAP entity configuration information and target routing configuration information that are configured by the target CU for the IAB node, where the target routing configuration information is used to indicate a data forwarding routing relationship of the IAB node in a network controlled by the target CU.

In a possible implementation, the first target information includes at least one of the following: system information of the DU, SSB information of the DU, PCI information of the DU, TAC information of the DU, RAN-based RANAC information of the DU, uplink and downlink information of the DU, capability information of the DU, uplink and downlink load of the DU, power distribution information between the DU and an MT of the IAB node, guard symbol information corresponding to the DU, and interference information of a backhaul link corresponding to the DU.

In a possible implementation, the system information of the DU is any one of the following: MIB information, target SIB information, and other SIB information, where the other SIB information is SIB information other than the target SIB information. The system information of the DU includes at least one of the following: PLMN information of a cell corresponding to the DU, BWP information corresponding to the DU, carrier information corresponding to the DU, and slice information corresponding to the DU, general random access information corresponding to the DU, IAB-specific random access information corresponding to the DU, paging configuration information corresponding to the DU, neighboring cell information corresponding to the DU, cell selection configuration information corresponding to the DU, broadcast message transmission configuration information corresponding to the DU, and radio resource configuration information corresponding to the DU.

In a possible implementation, the capability information of the DU includes at least one of the following: scheduling/transmission/reception processing latency of the DU, radio frequency information of the DU, band and carrier supported by the DU, dynamic power adjustment range of the DU, indication information whether the DU supports dual connectivity, indication information whether the DU supports EN-DC, multiplexing pattern supported by the DU, SCS information supported by an antenna configuration corresponding to the DU, scheduling pattern supported by the DU, DRX function information of the DU, preemptive BSR function information corresponding to the DU, downlink hop by hop flow control function information of the DU, RRC inactive state function information corresponding to the DU, RRC idle state function information corresponding to the DU, traffic class information supported by the DU, and MIMO related capability information supported by the DU.

In a possible implementation, the migration request message further includes third target information, and the third target information is relevant context information of the IAB node. The third target information includes at least one of the following: information about a BAP entity corresponding to the IAB node, configuration information of a BH RLC channel from the IAB node to a parent IAB node or a child IAB node, routing configuration information of the IAB node, local offloading configuration information of the IAB node, bearer mapping configuration information of the IAB node, congestion status information of a route or BH RLC channel, measurement configuration information of the IAB node for an NR cell or LTE cell, and IP address information corresponding to the IAB node.

In a possible implementation, the migration request message further includes at least one of the following: capability information of an MT of the IAB node and type information of the MT, where the capability information is used to indicate a user equipment UE function supported by the MT.

The network migration apparatus provided in this embodiment of this application can implement all processes implemented by the source CU in the foregoing method embodiment. To avoid repetition, details are not described herein again.

In the network migration apparatus provided in this embodiment of this application, the source CU can send the context information of the DU of the migrating IAB node to the target CU, so that the target CU can send the first configuration information (that is, the information for network migration configured by the target CU for the DU) to the source CU according to the context information of the DU; and the source CU sends the first configuration information to the IAB node, so that the IAB node implements the migration procedure of the DU according to the first configuration information. In this way, the migrating IAB-DU can migrate from a source network to a target network.

The network migration apparatus in this embodiment of this application may be an apparatus, or may be a component, an integrated circuit, or a chip in the source CU.

FIG. 7 is a possible schematic structural diagram of a network migration apparatus according to an embodiment of this application. As shown in FIG. 7, the network migration apparatus 70 provided in this embodiment of this application may include a receiving module 71 and a sending module 72.

The receiving module 71 is configured to receive a migration request message sent by a source CU, where the migration request message includes first target information, and the first target information is context information of a DU of a migrating IAB node. The sending module 72 is configured to send a migration response message to the source CU according to the migration request message, where the migration response message includes first configuration information, and the first configuration information is information for network migration configured by a target CU for the DU.

In a possible implementation, the migration request message further includes second target information, and the second target information is context information of an MT of the IAB node. The migration response message further includes second configuration information, and the second configuration information is information for network migration configured by the target CU for the MT.

In a possible implementation, the second configuration information includes at least one of the following: SRB information, DRB information, serving cell information, power control information, measurement report information, Uu cell configuration information of the DU, time-frequency resource configuration information, and routing information.

In a possible implementation, the migration response message further includes at least one of the following: BAP entity configuration information and target routing configuration information that are configured by the target CU for the IAB node, where the target routing configuration information is used to indicate a data forwarding routing relationship of the IAB node in a network controlled by the target CU.

In a possible implementation, the first target information includes at least one of the following: system information of the DU, SSB information of the DU, PCI information of the DU, TAC information of the DU, RAN-based RANAC information of the DU, uplink and downlink information of the DU, capability information of the DU, uplink and downlink load of the DU, power distribution information between the DU and an MT of the IAB node, guard symbol information corresponding to the DU, and interference information of a backhaul link corresponding to the DU.

In a possible implementation, the system information of the DU is any one of the following: MIB information, target SIB information, and other SIB information, where the other SIB information is SIB information other than the target SIB information. The system information of the DU includes at least one of the following: PLMN information of a cell corresponding to the DU, BWP information corresponding to the DU, carrier information corresponding to the DU, and slice information corresponding to the DU, general random access information corresponding to the DU, IAB-specific random access information corresponding to the DU, paging configuration information corresponding to the DU, neighboring cell information corresponding to the DU, cell selection configuration information corresponding to the DU, broadcast message transmission configuration information corresponding to the DU, and radio resource configuration information corresponding to the DU.

In a possible implementation, the capability information of the DU includes at least one of the following: scheduling/transmission/reception processing latency of the DU, radio frequency information of the DU, band and carrier supported by the DU, dynamic power adjustment range of the DU, indication information whether the DU supports dual connectivity, indication information whether the DU supports EN-DC, multiplexing pattern supported by the DU, SCS information supported by an antenna configuration corresponding to the DU, scheduling pattern supported by the DU, DRX function information of the DU, preemptive BSR function information corresponding to the DU, downlink hop by hop flow control function information of the DU, RRC inactive state function information corresponding to the DU, RRC idle state function information corresponding to the DU, traffic class information supported by the DU, and MIMO related capability information supported by the DU.

In a possible implementation, the migration request message further includes third target information, and the third target information is relevant context information of the IAB node. The third target information includes at least one of the following: information about a BAP entity corresponding to the IAB node, configuration information of a BH RLC channel from the IAB node to a parent IAB node or a child IAB node, routing configuration information of the IAB node, local offloading configuration information of the IAB node, bearer mapping configuration information of the IAB node, congestion status information of a route or BH RLC channel, measurement configuration information of the IAB node for an NR cell or LTE cell, and IP address information corresponding to the IAB node.

In a possible implementation, the migration request message further includes at least one of the following: capability information of an MT of the IAB node and type information of the MT, where the capability information is used to indicate a user equipment UE function supported by the MT.

The network migration apparatus provided in this embodiment of this application can implement all processes implemented by the target CU in the foregoing method embodiment. To avoid repetition, details are not described herein again.

In the network migration apparatus provided in this embodiment of this application, the target CU can send the first configuration information (that is, the information for network migration configured by the target CU for the DU) to the source CU according to the context information of the DU of the migrating IAB node sent by the source CU, and the source CU sends the first configuration information to the IAB node, so that the IAB node implements the migration procedure of the DU according to the first configuration information. In this way, the migrating IAB-DU can migrate from a source network to a target network.

The network migration apparatus in this embodiment of this application may be an apparatus, or may be a component, an integrated circuit, or a chip in the target CU.

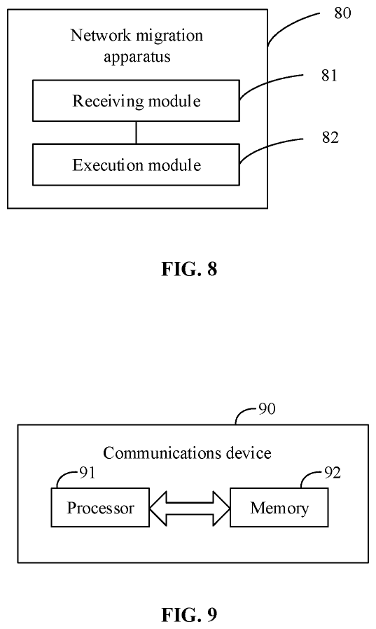

FIG. 8 is a possible schematic structural diagram of a network migration apparatus according to an embodiment of this application. As shown in FIG. 8, the network migration apparatus 80 provided in this embodiment of this application may include a receiving module 81 and an execution module 82.

The receiving module 81 is configured to receive first configuration information sent by a source CU, where the first configuration information is information for network migration configured by a target CU for a DU of an IAB node. The execution module 82 is configured to implement a migration procedure of the DU according to the first configuration information.

In a possible implementation, the receiving module 81 is further configured to receive second configuration information sent by the source CU, where the second configuration information is information configured by the target CU to an MT for network migration. The execution module 82 is further configured to implement a migration procedure of the MT according to the second configuration information.

In a possible implementation, the second configuration information includes at least one of the following: SRB information, DRB information, serving cell information, power control information, measurement report information, Uu cell configuration information of the DU, time-frequency resource configuration information, and routing information.

The network migration apparatus provided in this embodiment of this application can implement all processes implemented by the IAB node in the foregoing method embodiment. To avoid repetition, details are not described herein again.

In the network migration apparatus provided in this embodiment of this application, the IAB node can implement the migration procedure of the DU according to the first configuration information (that is, the information for network migration configured by the target CU for the DU) sent by the source CU. In this way, the migrating IAB-DU can migrate from a source network to a target network.

The network migration apparatus in this embodiment of this application may be an apparatus, or may be a component, an integrated circuit, or a chip in the IAB node.

Optionally, as shown in FIG. 9, an embodiment of this application further provides a communications device 90, including a processor 91, a memory 92, and a program or instructions stored in the memory 92 and capable of running on the processor 91. For example, if the communications device 90 is a source CU, when the program or instructions are executed by the processor 91, the processes implemented by the source CU in the foregoing method embodiment are implemented, with the same technical effects achieved. To avoid repetition, details are not further described herein. If the communications device 90 is a target CU, when the program or instructions are executed by the processor 91, the processes implemented by the target CU in the foregoing method embodiment are implemented, with the same beneficial effects achieved. To avoid repetition, details are not described herein again. If the communications device 90 is an IAB node, when the program or instructions are executed by the processor 91, the processes implemented by the IAB node in the foregoing method embodiment are implemented, with the same beneficial effects achieved. To avoid repetition, details are not described herein again.

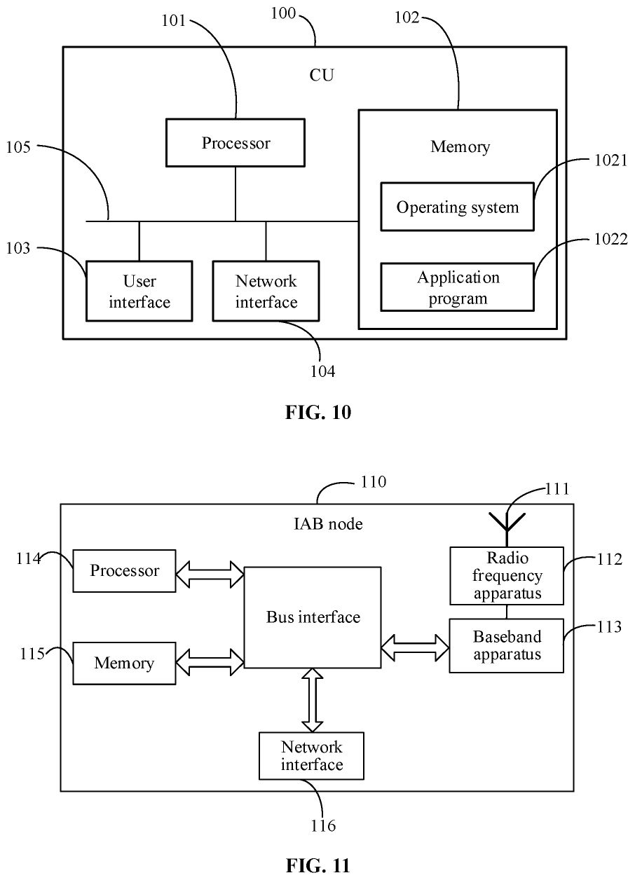

An embodiment of this application further provides a CU. FIG. 10 is a schematic diagram of a hardware structure of a CU for implementing the embodiments of this application.

It should be noted that the hardware structure of the CU shown in FIG. 10 may be the hardware structure of the source CU or the hardware structure of the target CU in the foregoing embodiment.

The CU 100 includes but is not limited to at least one processor 101, a memory 102, a user interface 103, and at least one network interface 104. Components of the CU 100 are coupled together through a bus system 105.

It should be noted that a person skilled in the art can understand that the structure of the CU 100 shown in FIG. 10 does not constitute a limitation on the CU. The CU may include more or fewer components than shown in FIG. 10, or some components may be combined, or the components may be disposed in different manners.

In this embodiment of this application, the at least one network interface 104 is configured to: send a migration request message to a target CU, where the migration request message includes first target information, and the first target information is context information of a DU of a migrating IAB node; receive a migration response message sent by the target CU, where the migration response message includes first configuration information, and the first configuration information is information for network migration configured by the target CU for the DU; and send the first configuration information to the IAB node, where the first configuration information is for use by the IAB node to implement a migration procedure of the DU.

Alternatively, the at least one network interface 104 is configured to: receive a migration request message sent by a source CU, where the migration request message includes first target information, and the first target information is context information of a DU of a migrating IAB node; and send a migration response message to the source CU according to the migration request message, where the migration response message includes first configuration information, and the first configuration information is information for network migration configured by the target CU for the DU.

In this embodiment of this application, the source CU can send the context information of the DU of the migrating IAB node to the target CU, so that the target CU can send the first configuration information (that is, the information for network migration configured by the target CU for the DU) to the source CU according to the context information of the DU; and the source CU sends the first configuration information to the IAB node, so that the IAB node implements the migration procedure of the DU according to the first configuration information. In this way, the migrating IAB-DU can migrate from a source network to a target network.

Optionally, the at least one network interface 104 is further configured to send second configuration information to the IAB node, where the second configuration information is for use by the IAB node to implement a migration procedure of an MT of the IAB node.

It can be understood that the bus system 105 is used to implement a connection and communication between these components. In addition to a data bus, the bus system 105 further includes a power bus, a control bus, and a status signal bus. However, for clarity of description, various buses are marked as the bus system 105 in FIG. 10.

The user interface 103 may include a display, a keyboard, a pointing device (for example, a mouse, a trackball, a touch panel, or a touchscreen), or the like.

It can be understood that the memory 102 in this embodiment of this application may be a volatile memory or a non-volatile memory, or may include both a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), which is used as an external cache. By way of example but not restrictive description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDRSDRAM), an enhanced synchronous dynamic random access memory (enhanced SDRAM, ESDRAM), a synchronous link dynamic random access memory (synch link DRAM, SLDRAM), and a direct rambus random access memory (direct rambus RAM, DRRAM). The memory 102 described in this embodiment of this application is intended to include but not be limited to these and any other suitable types of memories.

In some implementations, the memory 102 stores the following elements: executable modules or data structures, or a subset thereof, or an extended set thereof: an operating system 1021 and an application program 1022.

The operating system 1021 includes various system programs, such as a framework layer, a core library layer, and a driver layer, for implementing various basic services and processing hardware-based tasks. The application program 1022 includes various application programs, such as a media player and a browser, for implementing various application services. A program for implementing the method in this embodiment of this application may be included in the application program 1022.

In this embodiment of this application, the CU 100 may further include a program or instructions stored on the memory 102 and capable of running on the processor 101, where when the program or instructions are executed by the processor 101, the steps of the methods provided in the embodiments of this application are implemented.

The method disclosed in the foregoing embodiments of this application may be applied to the processor 101 or implemented by the processor 101. The processor 101 may be an integrated circuit chip, having a signal processing capability. During implementation, the steps of the foregoing method may be completed by hardware integrated logic circuits in the processor 101 or instructions in the form of software. The foregoing processor 101 may be a general-purpose processor, a digital signal processor (DSP), an application-specific integrated circuit (ASIC), a field programmable gate array (FPGA) or other programmable logic device, a discrete gate or transistor logic device, or a discrete hardware component. The processor 101 can implement or perform the methods, steps, and logical block diagrams that are disclosed in the embodiments of this application. The general-purpose processor may be a microprocessor, or the processor may also be any conventional processor or the like. The steps of the methods disclosed with reference to the embodiments of this application may be directly implemented by a hardware decoding processor, or may be implemented by a combination of hardware and software modules in a decoding processor. The software module may be located in a computer-readable storage medium that is mature in the art, such as a random access memory, a flash memory, a read-only memory, a programmable read-only memory, or an electrically erasable programmable memory, or a register. The computer-readable storage medium is located in the memory 102, and the processor 101 fetches information in the memory 102, and completes the steps of the foregoing method in combination with its hardware. Specifically, the computer-readable storage medium stores a program or instructions, where when the program or instructions are executed by the processor 101, the steps in the method embodiments of the embodiments of this application are implemented.

It can be understood that the embodiments described in the embodiments of this application may be implemented by hardware, software, firmware, middleware, microcode, or a combination thereof. In implementation by hardware, a processing unit may be implemented in one or more ASICs, a DSP, a digital signal processing device (DSP Device, DSPD), a programmable logic device (PLD), an FPGA, a general-purpose processor, a controller, a microcontroller, a microprocessor, other electronic units used to implement the functions described in this application, or a combination thereof.

For software implementation, the technologies described in the embodiments of this application may be implemented by modules (for example, processes or functions) that perform the functions described in the embodiments of this application. Software code may be stored in the memory and executed by the processor. The memory may be implemented in or outside the processor.

An embodiment of this application further provides a readable storage medium, where the readable storage medium stores a program or instructions, and when the program or instructions are executed by the processor 101 shown in FIG. 10, the processes of the foregoing method embodiments are implemented, with the same technical effects achieved. To avoid repetition, details are not described herein again. The computer-readable storage medium is, for example, a ROM, a RAM, a magnetic disc, or an optical disk.

An embodiment of this application further provides an IAB node. FIG. 11 is a schematic diagram of a hardware structure of an IAB node for implementing the embodiments of this application.

As shown in FIG. 11, the IAB node 110 includes an antenna 111, a radio frequency apparatus 112, and a baseband apparatus 113. The antenna 111 is connected to the radio frequency apparatus 112. In an uplink direction, the radio frequency apparatus 112 receives information through the antenna 111, and transmits the received information to the baseband apparatus 113 for processing. In a downlink direction, the baseband apparatus 113 processes to-be-transmitted information, and transmits the information to the radio frequency apparatus 112; and the radio frequency apparatus 112 processes the received information and then transmits the information through the antenna 111.

The band processing apparatus may be located in the baseband apparatus 113. The method performed by the IAB node in the foregoing embodiment may be implemented by the baseband apparatus 113, and the baseband apparatus 113 includes a processor 114 and a memory 115.

The baseband apparatus 113 may include, for example, at least one baseband processing unit, where a plurality of chips are disposed on the baseband processing unit. As shown in FIG. 11, one of the chips, for example, the processor 114, is connected to the memory 115 to invoke the program in the memory 115 so as to execute the operations of the IAB node shown in the foregoing method embodiment.

The baseband apparatus 113 may further include a network interface 116, configured to exchange information with the radio frequency apparatus 112, where the interface is, for example, a common public radio interface (CPRI).

Specifically, the IAB node in this embodiment of this application further includes a program or instructions stored in the memory 115 and capable of running on the processor 114. The processor 114 invokes the program or instructions in the memory 115 to perform the methods performed by the modules described above, with the same technical effects achieved. To avoid repetition, details are not described herein again.

An embodiment of this application further provides a readable storage medium, where the readable storage medium stores a program or instructions, and when the program or instructions are executed by a processor, the processes of the foregoing method embodiments are implemented, with the same technical effects achieved. To avoid repetition, details are not described herein again.

The processor is the processor in the communications device described in the foregoing embodiment. The readable storage medium includes a computer-readable storage medium such as a ROM, a RAM, a magnetic disc, or an optical disc.

An embodiment of this application further provides a chip, where the chip includes a processor and a communications interface, the communications interface is coupled to the processor, and the processor is configured to run a program or instructions to implement the processes of the foregoing method embodiments, with the same technical effects achieved. To avoid repetition, details are not described herein again.

It should be understood that the chip in the embodiments of this application may also be referred to as a system-level chip, a system chip, a chip system, a system on chip, or the like.

It should be noted that in this specification, the terms “include” and “comprise”, or any of their variants are intended to cover a non-exclusive inclusion, such that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

According to the description of the foregoing embodiments, persons skilled in the art can clearly understand that the method in the foregoing embodiments may be implemented by software in addition to a necessary universal hardware platform or by hardware only. In most cases, the former is a preferred implementation. Based on such an understanding, the technical solutions of this application essentially, or the part contributing to the prior art may be implemented in a form of a software product. The software product is stored in a storage medium (for example, ROM/RAM, a magnetic disk, or an optical disc), and includes several instructions for instructing a terminal (which may be a mobile phone, a computer, a server, an air conditioner, a network device, or the like) to perform the method described in the embodiments of this application.

The foregoing describes the embodiments of this application with reference to the accompanying drawings. However, this application is not limited to these specific embodiments. The specific embodiments are merely illustrative rather than restrictive. Inspired by this application, persons of ordinary skill in the art may develop many other manners without departing from the principle of this application and the protection scope of the claims, and all such manners fall within the protection scope of this application.

What is claimed is:

1. A network migration method, wherein the method comprises:
sending, by a source centralized unit CU, a migration request message to a target CU, wherein the migration request message comprises first target information, and the first target information is context information of a distributed unit DU of a migrating integrated access backhaul IAB node;
receiving, by the source CU, a migration response message sent by the target CU, wherein the migration response message comprises first configuration information, and the first configuration information is information for network migration configured by the target CU for the DU; and
sending, by the source CU, the first configuration information to the IAB node, wherein the first configuration information is for use by the IAB node to implement a migration procedure of the DU.

2. The method according to claim 1, wherein the migration request message further comprises second target information, and the second target information is context information of a mobile termination MT of the IAB node; and the migration response message further comprises second configuration information, and the second configuration information is information for network migration configured by the target CU for the MT; and
the method further comprises:
sending, by the source CU, the second configuration information to the IAB node, wherein the second configuration information is for use by the IAB node to implement a migration procedure of the MT.

3. The method according to claim 2, wherein the second configuration information comprises at least one of the following: signaling radio bearer SRB information, data radio bearer DRB information, serving cell information, power control information, measurement report information, Uu cell configuration information of the DU, time-frequency resource configuration information, and routing information.

4. The method according to claim 1, wherein the migration response message further comprises at least one of the following: backhaul adaptation protocol BAP entity configuration information and target routing configuration information that are configured by the target CU for the IAB node, wherein the target routing configuration information is used to indicate a data forwarding routing relationship of the IAB node in a network controlled by the target CU.

5. The method according to claim 1, wherein the first target information comprises at least one of the following: system information of the DU, synchronization signal block SSB information of the DU, physical cell identifier PCI information of the DU, tracking area code TAC information of the DU, radio access network RAN based notification area code RANAC information of the DU, uplink and downlink information of the DU, capability information of the DU, uplink and downlink load of the DU, power distribution information between the DU and an MT of the IAB node, guard symbol information corresponding to the DU, and interference information of a backhaul link corresponding to the DU.

6. The method according to claim 5, wherein the system information of the DU is any one of the following: master system information block MIB information, target system information block SIB information, and other SIB information, wherein the other SIB information is SIB information other than the target SIB information; and
the system information of the DU comprises at least one of the following: public land mobile network PLMN information of a cell corresponding to the DU, bandwidth part BWP configuration information corresponding to the DU, carrier configuration information corresponding to the DU, slice configuration information corresponding to the DU, general random access configuration information corresponding to the DU, IAB-specific random access configuration information corresponding to the DU, paging configuration information corresponding to the DU, neighboring cell information corresponding to the DU, cell selection configuration information corresponding to the DU, broadcast message transmission configuration information corresponding to the DU, and radio resource configuration information corresponding to the DU.

7. The method according to claim 5, wherein the capability information of the DU comprises at least one of the following: scheduling/transmission/reception processing latency of the DU, radio frequency information of the DU, band and carrier supported by the DU, dynamic power adjustment range of the DU, indication information whether the DU supports dual connectivity, indication information whether the DU supports EN-DC, multiplexing pattern supported by the DU, subcarrier spacing SCS information supported by an antenna configuration corresponding to the DU, scheduling pattern supported by the DU, discontinuous reception DRX function information of the DU, preemptive buffer status report BSR function information corresponding to the DU, downlink hop by hop flow control function information of the DU, radio resource control RRC inactive state function information corresponding to the DU, RRC idle state function information corresponding to the DU, traffic class information supported by the DU, and multiple input multiple output MIMO related capability information supported by the DU.

8. The method according to claim 1, wherein the migration request message further comprises third target information, and the third target information is relevant context information of the IAB node; and
the third target information comprises at least one of the following: information about a BAP entity corresponding to the IAB node, configuration information of a backhaul BH radio link control RLC channel from the IAB node to a parent IAB node or a child IAB node, routing configuration information of the IAB node, local offloading configuration information of the IAB node, bearer mapping configuration information of the IAB node, congestion status information of a route or BH RLC channel, measurement configuration information of the IAB node for a new radio NR cell or long term evolution LTE cell, and internet protocol IP address information corresponding to the IAB node.

9. The method according to claim 1, wherein the migration request message further comprises at least one of the following: capability information of an MT of the IAB node and type information of the MT, wherein the capability information is used to indicate a user equipment UE function supported by the MT.

10. A network migration method, wherein the method comprises:
receiving, by a target centralized unit CU, a migration request message sent by a source CU, wherein the migration request message comprises first target information, and the first target information is context information of a distributed unit DU of a migrating integrated access backhaul IAB node; and
sending, by the target CU, a migration response message to the source CU according to the migration request message, wherein the migration response message comprises first configuration information, and the first configuration information is information for network migration configured by the target CU for the DU.

11. The method according to claim 10, wherein the migration request message further comprises second target information, and the second target information is context information of a mobile termination MT of the IAB node; and
the migration response message further comprises second configuration information, and the second configuration information is information for network migration configured by the target CU for the MT.

12. The method according to claim 10, wherein the second configuration information comprises at least one of the following: signaling radio bearer SRB information, data radio bearer DRB information, serving cell information, power control information, measurement report information, Uu cell configuration information of the DU, time-frequency resource configuration information, and routing information.

13. The method according to claim 10, wherein the first target information comprises at least one of the following: system information of the DU, synchronization signal block SSB information of the DU, physical cell identifier PCI information of the DU, tracking area code TAC information of the DU, radio access network RAN based notification area code RANAC information of the DU, uplink and downlink information of the DU, capability information of the DU, uplink and downlink load of the DU, power distribution information between the DU and an MT of the IAB node, guard symbol information corresponding to the DU, and interference information of a backhaul link corresponding to the DU.

14. The method according to claim 13, wherein the system information of the DU is any one of the following: master system information block MIB information, target system information block SIB information, and other SIB information, wherein the other SIB information is SIB information other than the target SIB information; and
the system information of the DU comprises at least one of the following: public land mobile network PLMN information of a cell corresponding to the DU, bandwidth part BWP configuration information corresponding to the DU, carrier configuration information corresponding to the DU, and slice configuration information corresponding to the DU, general random access configuration information corresponding to the DU, paging configuration information corresponding to the DU, neighboring cell information corresponding to the DU, cell selection configuration information corresponding to the DU, broadcast message transmission configuration information corresponding to the DU, and radio resource configuration information corresponding to the DU.

15. The method according to claim 13, wherein the capability information of the DU comprises at least one of the following: scheduling/transmission/reception processing latency of the DU, radio frequency information of the DU, band and carrier supported by the DU, dynamic power adjustment range of the DU, indication information whether the DU supports dual connectivity, indication information whether the DU supports EN-DC, multiplexing pattern supported by the DU, subcarrier spacing SCS information supported by an antenna configuration corresponding to the DU, scheduling pattern supported by the DU, discontinuous reception DRX function information of the DU, preemptive buffer status report BSR function information corresponding to the DU, downlink hop by hop flow control function information of the DU, radio resource control RRC inactive state function information corresponding to the DU, RRC idle state function information corresponding to the DU, traffic class information supported by the DU, and multiple input multiple output MIMO related capability information supported by the DU.

16. The method according to claim 10, wherein the migration request message further comprises third target information, and the third target information is relevant context information of the IAB node; and
the third target information comprises at least one of the following: information about a BAP entity corresponding to the IAB node, configuration information of a backhaul BH radio link control RLC channel from the IAB node to a parent IAB node or a child IAB node, routing configuration information of the IAB node, local offloading configuration information of the IAB node, bearer mapping configuration information of the IAB node, congestion status information of a route or BH RLC channel, measurement configuration information of the IAB node for a new radio NR cell or long term evolution LTE cell, and internet protocol IP address information corresponding to the IAB node.

17. A network migration method, wherein the method comprises:
receiving, by an integrated access backhaul IAB node, first configuration information sent by a source centralized unit CU, wherein the first configuration information is information for network migration configured by a target CU for a distributed unit DU of the IAB node; and
implementing, by the IAB node, a migration procedure of the DU according to the first configuration information.

18. A centralized unit CU, comprising a processor, a memory, and a program or instructions stored in the memory and capable of running on the processor, wherein when the program or instructions are executed by the processor, the steps of the network migration method according to claim 1 are implemented.

19. A centralized unit CU, comprising a processor, a memory, and a program or instructions stored in the memory and capable of running on the processor, wherein when the program or instructions are executed by the processor, the steps of the network migration method according to claim 10 are implemented.

20. An integrated access backhaul IAB node, comprising a processor, a memory, and a program or instructions stored in the memory and capable of running on the processor, wherein when the program or instructions are executed by the processor, the steps of the network migration method according to claim 17 are implemented.
